(19) United States
(12) Patent Application Publication
(10) Pub. No.: US 2020/0170045 A1
(43) Pub. Date: May 28, 2020

(54) METHOD FOR PERFORMING A RANDOM ACCESS PROCEDURE IN WIRELESS COMMUNICATION SYSTEM AND A DEVICE THEREFOR

(71) Applicant: LG ELECTRONICS INC., Seoul (KR)

(72) Inventors: Jeonggu LEE, Seoul (KR); Sunyoung LEE, Seoul (KR)

(73) Assignee: LG ELECTRONICS INC., Seoul (KR)

(21) Appl. No.: 16/636,894

(22) PCT Filed: Aug. 7, 2018
(86) PCT No.: PCT/KR2018/008925

§ 371 Date: Feb. 5, 2020

Related U.S. Application Data
(60) Provisional application No. 62/542,304, filed on Aug. 8, 2017.

(51) Int. Cl. H04W 74/08; H04W 24/08; H04W 72/04; H04L 1/18; H04L 5/00; H04W 76/11; H04W 4/40

(52) U.S. Cl. CPC H04W 74/0833; H04W 24/08; H04W 72/042; H04W 4/40; H04L 5/0055; H04W 76/11; H04L 1/1819

(57) ABSTRACT

The present invention relates to a wireless communication system. More specifically, the present invention relates to a method and a device for performing a random access procedure in wireless communication system, the method comprising: starting a timer when a Msg3 for a RA procedure is transmitted to a base station; monitoring a Physical Downlink Control Channel (PDCCH) while the timer is running; and stopping the timer if the PDCCH including uplink resource for the retransmission of the Msg3 is received

### TECHNICAL FIELD

The present invention relates to a wireless communication system and, more particularly, to a method for performing a random access procedure in wireless communication system and a device therefor.

### BACKGROUND ART

As an example of a mobile communication system to which the present invention is applicable, a 3rd Generation Partnership Project Long Term Evolution (hereinafter, referred to as LTE) communication system is described in brief

FIG. 1 is a view schematically illustrating a network structure of an Evolved Universal Mobile Telecommunications System (E-UMTS) as an exemplary radio communication system. The E-UMTS is an advanced version of a conventional Universal Mobile Telecommunications System (UMTS) and basic standardization thereof is currently underway in the 3GPP. E-UMTS may be generally referred to as a Long Term Evolution (LTE) system. The communication network is widely deployed to provide a variety of communication services such as voice (VoIP) through IMS and packet data.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE and NR based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

As more and more communication devices demand larger communication capacity, there is a need for improved mobile broadband communication compared to existing RAT. Also, massive machine type communication (MTC), which provides various services by connecting many devices and objects, is one of the major issues to be considered in the next generation communication. In addition, a communication system design considering a service/UE sensitive to reliability and latency is being discussed. The introduction of next-generation RAT, which takes into account such Enhanced Mobile BroadBand (eMBB) transmission, and ultra-reliable and low latency communication (URLLC) transmission, is being discussed.

### DISCLOSURE

### Technical Problem

An object of the present invention devised to solve the problem lies in a method and device for performing a random access procedure in wireless communication system.

In RA procedure, the UE starts a contention resolution timer once the Msg3 is transmitted. Every Msg3 transmission, the UE restarts the contention resolution timer. The purpose of contention resolution timer is to receive a PDCCH for Msg4 scheduling or Msg3 retransmission.

However, after UE receives a UL grant for the next Msg3 retransmission, the UE may not need to monitor the PDCCH until the next Msg3 retransmission has been transmitted because the UE is not expected to receive any other PDCCH scheduling the Msg3 retransmission. The network may schedule another retransmission of Msg3 even after the network already scheduled the retransmission of Msg3. But, it costs UE unnecessary power consumption while the benefit/motivation is not so clear.

The technical problems solved by the present invention are not limited to the above technical problems and those skilled in the art may understand other technical problems from the following description.

### Technical Solution

The object of the present invention can be achieved by providing a method for User Equipment (UE) operating in a wireless communication system as set forth in the appended claims.

In another aspect of the present invention, provided herein is a communication apparatus as set forth in the appended claims.

It is to be understood that both the foregoing general description and the following detailed description of the present invention are exemplary and explanatory and are intended to provide further explanation of the invention as claimed.

### Advantageous Effects

To avoid unnecessary power consumption, we propose that the UE stops contention resolution timer when the UE receives an UL grant for the next Msg3 retransmission.

Considering that contention resolution timer is running for every Msg3 transmission, the more the Msg3 retransmission occurs, the more the UE power consumptions are. Therefore, we see some gain of stopping contention resolution timer.

It will be appreciated by persons skilled in the art that the effects achieved by the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a diagram showing a network structure of an Evolved Universal Mobile Telecommunications System (E-UMTS) as an example of a wireless communication system;

FIG. 2a is a block diagram illustrating network structure of an evolved universal mobile telecommunication system (E-UMTS), and FIG. 2b is a block diagram depicting architecture of a typical E-UTRAN and a typical EPC;

FIG. 3 is a diagram showing a control plane and a user plane of a radio interface protocol between a UE and an E-UTRAN based on a 3rd generation partnership project (3GPP) radio access network standard;

FIG. 4a is a block diagram illustrating network structure of NG Radio Access Network (NG-RAN) architecture, and FIG. 4b is a block diagram depicting architecture of functional Split between NG-RAN and 5G Core Network (5GC);

FIG. 5 is a diagram showing a control plane and a user plane of a radio interface protocol between a UE and a NG-RAN based on a 3rd generation partnership project (3GPP) radio access network standard;

FIG. 6 is a block diagram of a communication apparatus according to an embodiment of the present invention;

FIG. 7 is a view illustrating an operating procedure of a UE and an eNB in a contention based random access procedure;

FIG. 8 is an example for stop condition for a contention resolution timer after receiving a PDCCH for the next Msg3 retransmission;

FIG. 9 is a conceptual diagram for performing a random access procedure in wireless communication system according to embodiments of the present invention; and

FIG. 10 is an example for performing a random access procedure in wireless communication system according to embodiments of the present invention.

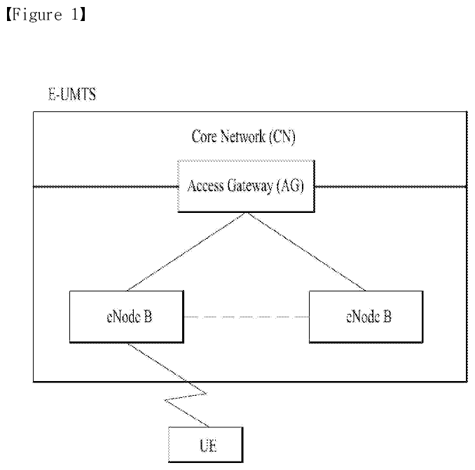

### BEST MODE

Universal mobile telecommunications system (UMTS) is a 3rd Generation (3G) asynchronous mobile communication system operating in wideband code division multiple access (WCDMA) based on European systems, global system for mobile communications (GSM) and general packet radio services (GPRS). The long-term evolution (LTE) of UMTS is under discussion by the 3rd generation partnership project (3GPP) that standardized UMTS.

The 3GPP LTE is a technology for enabling high-speed packet communications. Many schemes have been proposed for the LTE objective including those that aim to reduce user and provider costs, improve service quality, and expand and improve coverage and system capacity. The 3G LTE requires reduced cost per bit, increased service availability, flexible use of a frequency band, a simple structure, an open interface, and adequate power consumption of a terminal as an upper-level requirement.

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

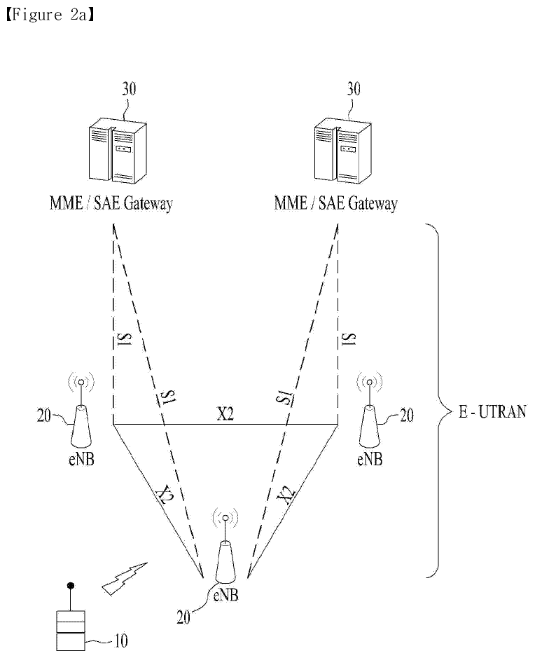

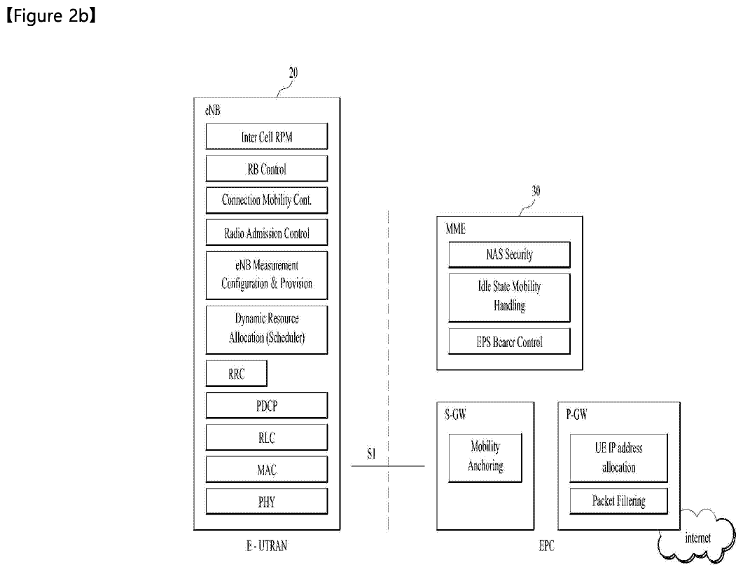

FIG. 2a is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2a, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNodeB 20 to UE 10, and “uplink” refers to communication from the UE to an eNodeB. UE 10 refers to communication equipment carried by a user and may be also referred to as a mobile station (MS), a user terminal (UT), a subscriber station (SS) or a wireless device.

FIG. 2b is a block diagram depicting architecture of a typical E-UTRAN and a typical EPC.

As illustrated in FIG. 2b, an eNodeB 20 provides end points of a user plane and a control plane to the UE 10. MME/SAE gateway 30 provides an end point of a session and mobility management function for UE 10. The eNodeB and MME/SAE gateway may be connected via an S1 interface.

The eNodeB 20 is generally a fixed station that communicates with a UE 10, and may also be referred to as a base station (BS) or an access point. One eNodeB 20 may be deployed per cell. An interface for transmitting user traffic or control traffic may be used between eNodeBs 20.

The MME provides various functions including NAS signaling to eNodeBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW and Serving GW selection, MME selection for handovers with MME change, SGSN selection for handovers to 2G or 3G 3GPP access networks, Roaming, Authentication, Bearer management functions including dedicated bearer establishment, Support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNodeB 20 and gateway 30 via the Si interface. The eNodeBs 20 may be connected to each other via an X2 interface and neighboring eNodeBs may have a meshed network structure that has the X2 interface.

As illustrated, eNodeB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNodeB measurements, radio bearer control, radio admission control (RAC), and connection mobility control in LTE ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

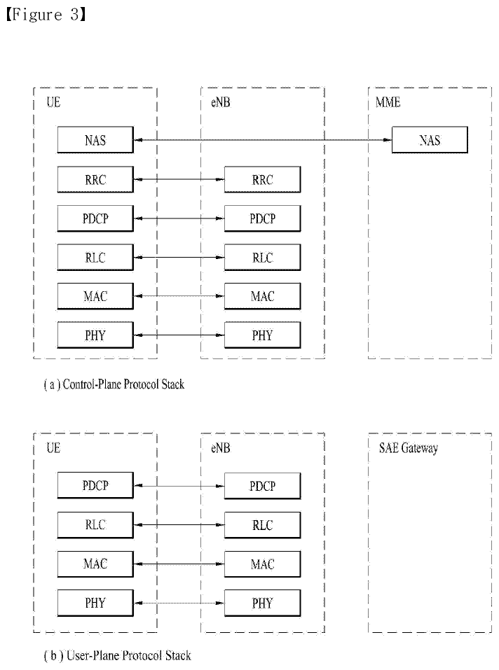

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

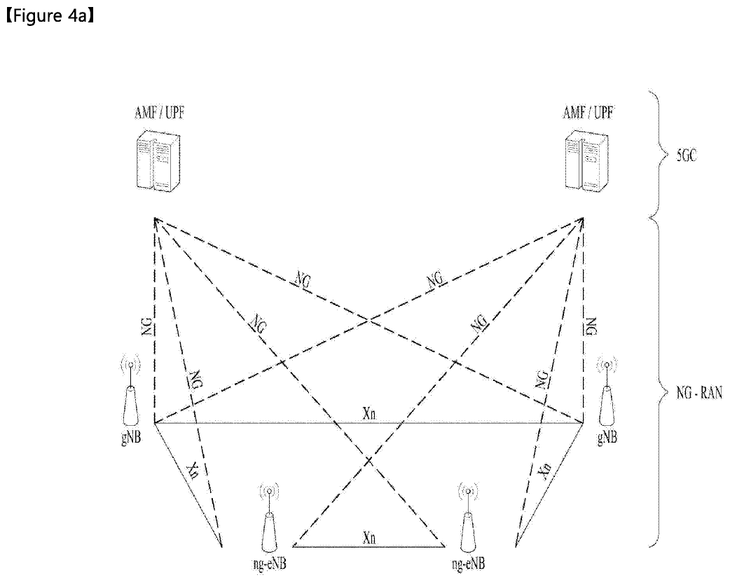

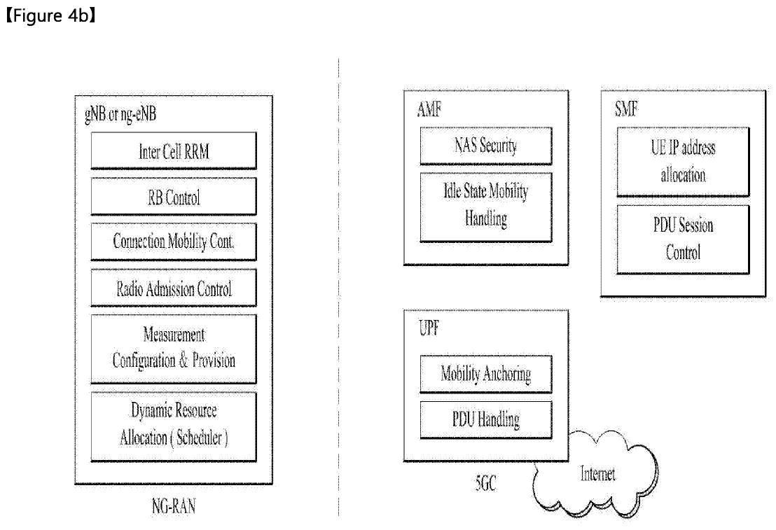

FIG. 4a is a block diagram illustrating network structure of NG Radio Access Network (NG-RAN) architecture, and FIG. 4b is a block diagram depicting architecture of functional Split between NG-RAN and 5G Core Network (5GC).

An NG-RAN node is a gNB, providing NR user plane and control plane protocol terminations towards the UE, or an ng-eNB, providing E-UTRA user plane and control plane protocol terminations towards the UE.

The gNBs and ng-eNBs are interconnected with each other by means of the Xn interface. The gNBs and ng-eNBs are also connected by means of the NG interfaces to the 5GC, more specifically to the AMF (Access and Mobility Management Function) by means of the NG-C interface and to the UPF (User Plane Function) by means of the NG-U interface.

The Xn Interface includes Xn user plane (Xn-U), and Xn control plane (Xn-C). The Xn User plane (Xn-U) interface is defined between two NG-RAN nodes. The transport network layer is built on IP transport and GTP-U is used on top of UDP/IP to carry the user plane PDUs. Xn-U provides non-guaranteed delivery of user plane PDUs and supports the following functions: i) Data forwarding, and ii) Flow control. The Xn control plane interface (Xn-C) is defined between two NG-RAN nodes. The transport network layer is built on SCTP on top of IP. The application layer signalling protocol is referred to as XnAP (Xn Application Protocol). The SCTP layer provides the guaranteed delivery of application layer messages. In the transport IP layer point-to-point transmission is used to deliver the signalling PDUs. The Xn-C interface supports the following functions: i) Xn interface management, ii) UE mobility management, including context transfer and RAN paging, and iii) Dual connectivity.

The NG Interface includes NG User Plane (NG-U) and NG Control Plane (NG-C). The NG user plane interface (NG-U) is defined between the NG-RAN node and the UPF. The transport network layer is built on IP transport and GTP-U is used on top of UDP/IP to carry the user plane PDUs between the NG-RAN node and the UPF. NG-U provides non-guaranteed delivery of user plane PDUs between the NG-RAN node and the UPF.

The NG control plane interface (NG-C) is defined between the NG-RAN node and the AMF. The transport network layer is built on IP transport. For the reliable transport of signalling messages, SCTP is added on top of IP. The application layer signalling protocol is referred to as NGAP (NG Application Protocol). The SCTP layer provides guaranteed delivery of application layer messages. In the transport, IP layer point-to-point transmission is used to deliver the signalling PDUs.

NG-C provides the following functions: i) NG interface management, ii) UE context management, iii) UE mobility management, iv) Configuration Transfer, and v) Warning Message Transmission.

The gNB and ng-eNB host the following functions: i) Functions for Radio Resource Management: Radio Bearer Control, Radio Admission Control, Connection Mobility Control, Dynamic allocation of resources to UEs in both uplink and downlink (scheduling), ii) IP header compression, encryption and integrity protection of data, iii) Selection of an AMF at UE attachment when no routing to an AMF can be determined from the information provided by the UE, iv) Routing of User Plane data towards UPF(s), v) Routing of Control Plane information towards AMF, vi) Connection setup and release, vii) Scheduling and transmission of paging messages (originated from the AMF), viii) Scheduling and transmission of system broadcast information (originated from the AMF or O&M), ix) Measurement and measurement reporting configuration for mobility and scheduling, x) Transport level packet marking in the uplink, xi) Session Management, xii) Support of Network Slicing, and xiii) QoS Flow management and mapping to data radio bearers. The Access and Mobility Management Function (AMF) hosts the following main functions: i) NAS signalling termination, ii) NAS signalling security, iii) AS Security control, iv) Inter CN node signalling for mobility between 3GPP access networks, v) Idle mode UE Reachability (including control and execution of paging retransmission), vi) Registration Area management, vii) Support of intra-system and inter-system mobility, viii) Access Authentication, ix) Mobility management control (subscription and policies), x) Support of Network Slicing, and xi) SMF selection.

The User Plane Function (UPF) hosts the following main functions: i) Anchor point for Intra-/Inter-RAT mobility (when applicable), ii) External PDU session point of interconnect to Data Network, iii) Packet inspection and User plane part of Policy rule enforcement, iv) Traffic usage reporting, v) Uplink classifier to support routing traffic flows to a data network, vi) QoS handling for user plane, e.g. packet filtering, gating, UL/DL rate enforcement, and vii) Uplink Traffic verification (SDF to QoS flow mapping).

The Session Management function (SMF) hosts the following main functions: i) Session Management, ii) UE IP address allocation and management, iii) Selection and control of UP function, iv) Configures traffic steering at UPF to route traffic to proper destination, v) Control part of policy enforcement and QoS, vi) Downlink Data Notification.

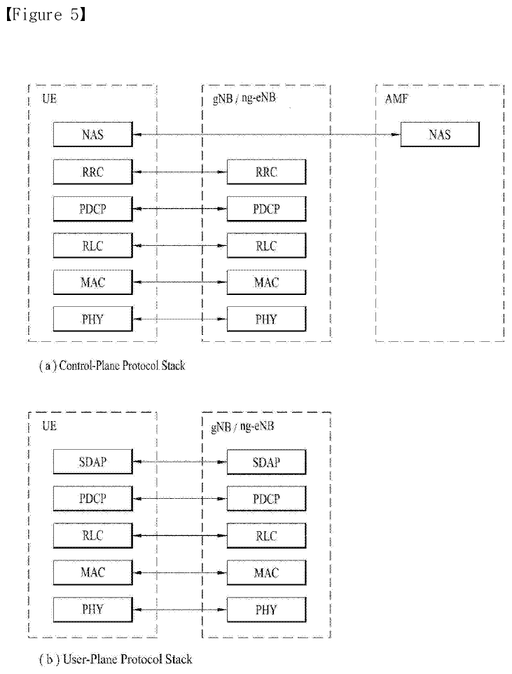

FIG. 5 is a diagram showing a control plane and a user plane of a radio interface protocol between a UE and a NG-RAN based on a 3rd generation partnership project (3GPP) radio access network standard.

The user plane protocol stack contains Phy, MAC, RLC, PDCP and SDAP (Service Data Adaptation Protocol) which is newly introduced to support 5G QoS model.

The main services and functions of SDAP entity include i) Mapping between a QoS flow and a data radio bearer, and ii) Marking QoS flow ID (QFI) in both DL and UL packets. A single protocol entity of SDAP is configured for each individual PDU session.

At the reception of an SDAP SDU from upper layer for a QoS flow, the transmitting SDAP entity may map the SDAP SDU to the default DRB if there is no stored QoS flow to DRB mapping rule for the QoS flow. If there is a stored QoS flow to DRB mapping rule for the QoS flow, the SDAP entity may map the SDAP SDU to the DRB according to the stored QoS flow to DRB mapping rule. And the SDAP entity may construct the SDAP PDU and deliver the constructed SDAP PDU to the lower layers.

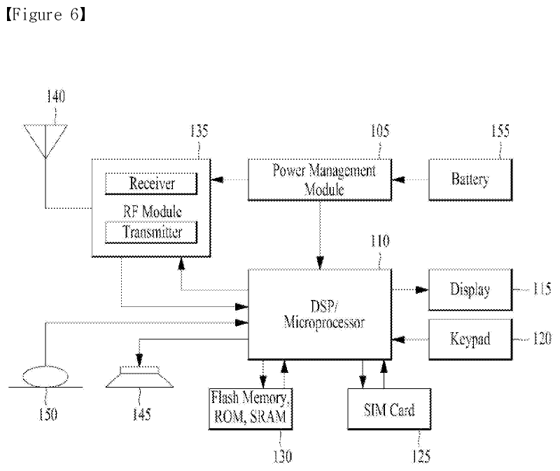

FIG. 6 is a block diagram of a communication apparatus according to an embodiment of the present invention.

The apparatus shown in FIG. 6 can be a user equipment (UE) and/or eNB or gNB adapted to perform the above mechanism, but it can be any apparatus for performing the same operation.

As shown in FIG. 6, the apparatus may comprises a DSP/microprocessor (110) and RF module (transmiceiver; 135). The DSP/microprocessor (110) is electrically connected with the transciver (135) and controls it. The apparatus may further include power management module (105), battery (155), display (115), keypad (120), SIM card (125), memory device (130), speaker (145) and input device (150), based on its implementation and designer's choice.

Specifically, FIG. 6 may represent a UE comprising a receiver (135) configured to receive a request message from a network, and a transmitter (135) configured to transmit the transmission or reception timing information to the network. These receiver and the transmitter can constitute the transceiver (135). The UE further comprises a processor (110) connected to the transceiver (135: receiver and transmitter).

Also, FIG. 6 may represent a network apparatus comprising a transmitter (135) configured to transmit a request message to a UE and a receiver (135) configured to receive the transmission or reception timing information from the UE. These transmitter and receiver may constitute the transceiver (135). The network further comprises a processor (110) connected to the transmitter and the receiver. This processor (110) may be configured to calculate latency based on the transmission or reception timing information.

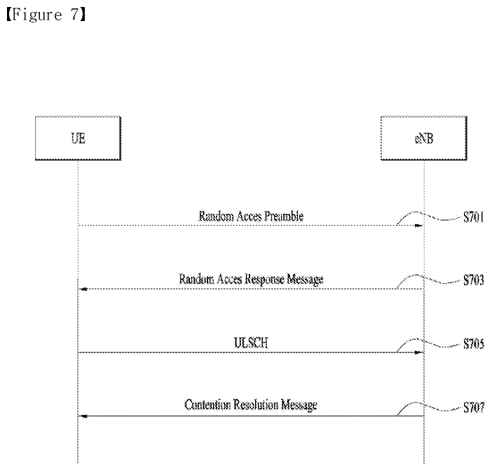

FIG. 7 is a view illustrating an operating procedure of a UE and an eNB in a contention based random access procedure.

The random access procedure takes two distinct forms. One is a contention based (applicable to first five events) random access procedure and the other one is a non-contention based (applicable to only handover, DL data arrival and positioning) random access procedure. The non-contention based random access procedure is also called as dedicated RACH process.

The random access procedure is performed for the following events related to the PCell: i) initial access from RRC_IDLE; ii) RRC Connection Re-establishment procedure; iii) Handover; iv) DL data arrival during RRC_CONNECTED requiring random access procedure (e.g. when UL synchronisation status is “non-synchronised”.), v) UL data arrival during RRC_CONNECTED requiring random access procedure (e.g. when UL synchronisation status is “non-synchronised” or there are no PUCCH resources for SR available.), and vi) For positioning purpose during RRC_CONNECTED requiring random access procedure; (e.g. when timing advance is needed for UE positioning.)

The random access procedure is also performed on a SCell to establish time alignment for the corresponding sTAG.

First, the UE may randomly select a single random access preamble from a set of random access preambles indicated through system information or a handover command, and select and transmit a Physical Random Access Channel (PRACH) capable of transmitting the random access preamble (S701).

There are two possible groups defined and one is optional. If both groups are configured the size of message 3 and the pathloss are used to determine which group a preamble is selected from. The group to which a preamble belongs provides an indication of the size of the message 3 and the radio conditions at the UE. The preamble group information along with the necessary thresholds are broadcast on system information.

A method of receiving random access response information is similar to the above-described non-contention based random access procedure. That is, the UE attempts to receive its own random access response within a random access response reception window indicated by the eNode B through the system information or the handover command, after the random access preamble is transmitted in step S701, and receives a Physical Downlink Shared Channel (PDSCH) using random access identifier information corresponding thereto (S703). Accordingly, the UE may receive a UL Grant, a Temporary C-RNTI, a TAC and the like.

If the UE has received the random access response valid for the UE, the UE may process all of the information included in the random access response. That is, the UE applies the TAC, and stores the temporary C-RNTI. In addition, data which will be transmitted in correspondence with the reception of the valid random access response may be stored in a Msg3 buffer.

The UE uses the received UL Grant so as to transmit the data (that is, the message 3) to the eNode B (S705). The message 3 should include a UE identifier. In the contention based random access procedure, the eNode B may not determine which UEs are performing the random access procedure, but later the UEs should be identified for contention resolution.

Here, two different schemes for including the UE identifier may be provided. A first scheme is to transmit the UE's cell identifier through an uplink transmission signal corresponding to the UL Grant if the UE has already received a valid cell identifier allocated by a corresponding cell prior to the random access procedure. Conversely, the second scheme is to transmit the UE's unique identifier (e.g., S-TMSI or random ID) if the UE has not received a valid cell identifier prior to the random access procedure. In general, the unique identifier is longer than the cell identifier. If the UE has transmitted data corresponding to the UL Grant, the UE starts a contention resolution (CR) timer.

After transmitting the data with its identifier through the UL Grant included in the random access response, the UE waits for an indication (instruction) from the eNode B for contention resolution. That is, the UE attempts to receive the PDCCH so as to receive a specific message (S707). Here, there are two schemes to receive the PDCCH. As described above, the UE attempts to receive the PDCCH using its own cell identifier if the message 3 transmitted in correspondence with the UL Grant is transmitted using the UE's cell identifier, and the UE attempts to receive the PDCCH using the temporary C-RNTI included in the random access response if the identifier is its unique identifier. Thereafter, in the former scheme, if the PDCCH is received through its own cell identifier before the contention resolution timer is expired, the UE determines that the random access procedure has been normally performed and completes the random access procedure. In the latter scheme, if the PDCCH is received through the temporary C-RNTI before the contention resolution timer has expired, the UE checks data transferred by the PDSCH indicated by the PDCCH. If the unique identifier of the UE is included in the data, the UE determines that the random access procedure has been normally performed and completes the random access procedure.

The Temporary C-RNTI is promoted to C-RNTI for a UE which detects RA success and does not already have a C-RNTI; it is dropped by others. A UE which detects RA success and already has a C-RNTI, resumes using its C-RNTI.

When CA is configured, the first three steps of the contention based random access procedures occur on the PCell while contention resolution can be cross-scheduled by the PCell.

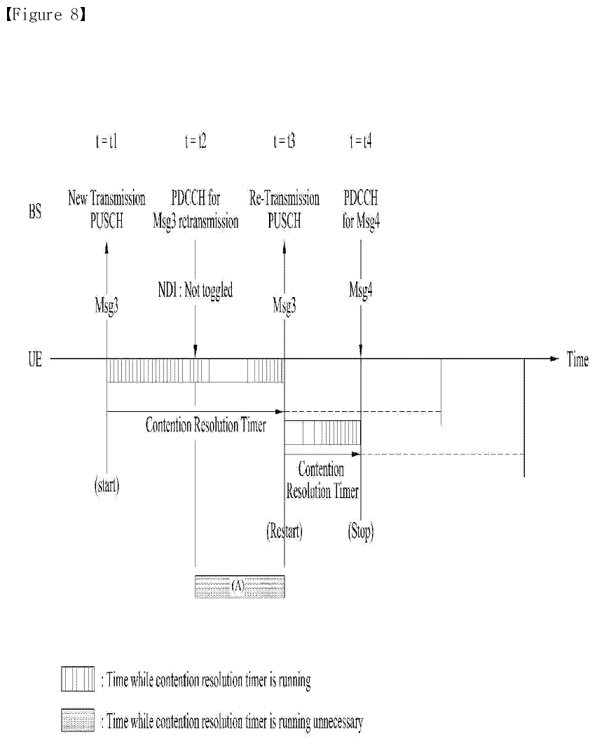

FIG. 8 is an example for stop condition for a contention resolution timer after receiving a PDCCH for the next Msg3 retransmission.

In TS 36.321, in RA procedure, the UE starts mac-ContentionResolutionTimer once the Msg3 is transmitted. Every Msg3 transmission, the UE restarts the mac-ContencionResolutionTimer. The purpose of mac-ContentionResolutionTimer is to receive a PDCCH for Msg4 scheduling or Msg3 retransmission. Thus, the mac-ContentionResolutionTimer is only stopped when a PDCCH transmission for Msg 4 is addressed to its Temporay C-RNTI and CCCH SDU was included in Msg 3; or a PDCCH transmission for the Msg 4 is addressed to C-RNTI and the C-RNTI MAC control element was included in the Msg 3.

In TS 38.321, in RA procedure, the UE starts the ra-ContentionResolutionTimer and restarts the ra-ContentionResolutionTimer at each HARQ retransmission in the first symbol after the end of the Msg3 transmission once the Msg3 is transmitted. The purpose of ra-ContentionResolutionTimer is same as purpose of mac-ContentionResolutionTimer in LTE.

Thus, the ra-ContentionResolutionTimer is only stopped when a PDCCH transmission for Msg 4 is addressed to its Temporay C-RNTI and CCCH SDU was included in Msg 3; or a PDCCH transmission for the Msg 4 is addressed to C-RNTI and the C-RNTI MAC control element was included in the Msg.

However, after UE receives a NDI not toggled on a PDCCH for the next Msg3 retransmission, the UE may not need to monitor the PDCCH until the next Msg3 retransmission has been transmitted because the UE is not expected to receive any other PDCCH scheduling the Msg3 retransmission. The network may schedule another retransmission of Msg3 even after the network already scheduled the retransmission of Msg3. But, it costs UE power consumption while the benefit/motivation is not so clear. Therefore, it may bring unnecessary power consumption if the UE doesn't stop the contention resolution timer even after the UE receives a PDCCH for Msg3 retransmission.

As shown FIG. 8, when the UE transmits Msg3 as a new transmission, the UE starts a contention resolution timer at t=t1. While the contention resolution timer is running, the UE receives a PDCCH for the Msg3 retransmission at t=t2. And the UE re-transmits the Msg3 and re-starts the contention resolution timer at t=t3. If the UE receives a PDCCH for Msg4, the UE stops contention resolution timer at t=t4. If the UE Contention Resolution Identity in the Msg4 (i.e. a MAC CE) matches the CCCH SDU transmitted in Msg3, or if the Msg4 (i.e. MAC PDU) contains a UE Contention Resolution Identity MAC CE, the UE considers this Random Access procedure successfully completed.

The problem is marked with (A) in FIG. 8. After receiving the PDCCH for the next Msg3 retransmission, the UE doesn't need to monitor the PDCCH until the UE has sent the Msg3 retransmission. But the contention resolution timer is still running during (A). Therefore, unnecessary power is consumed.

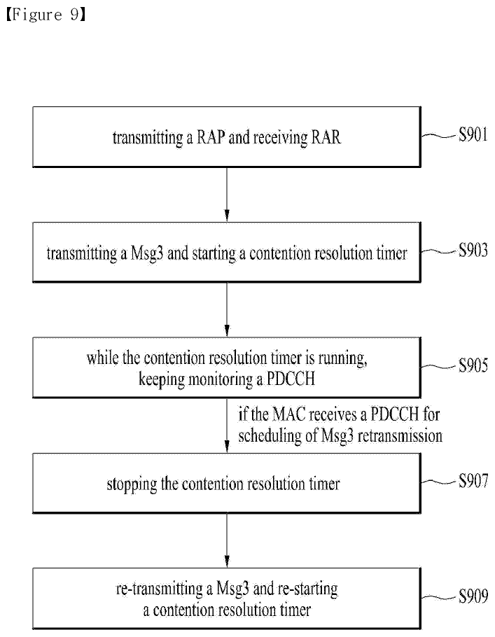

FIG. 9 is a conceptual diagram for performing a random access procedure in wireless communication system according to embodiments of the present invention.

In this invention, if a UE receives a scheduling of uplink resource for a Msg3 retransmission while a contention resolution timer is running, the UE stops the mac-contention resolution timer.

When the UE transmits a random access preamble (RAP) to a base station (e.g. eNB or gNB) and receives random access response (RAR) from the base station (S901).

The transmission of a RAP, allowing the base station to estimate the transmission timing of the terminal. Uplink synchronization is necessary as the UE otherwise cannot transmit any uplink data.

The RAR includes a timing advance command for adjusting the UE transmit timing, based on the timing estimate obtained in the RAP transmission. In addition to establishing uplink synchronization, the RAR also includes uplink resources to the UE to be used for transmitting Msg3 in the random-access procedure.

The UE transmits a Msg3 for a RA procedure to the base station and starts a contention resolution timer (S903).

Preferably, the transmission of Msg3 is a transmission of the UE identity to the base station using the UL-SCH similar to normal scheduled data. The exact content of Msg3 depends on the state of the UE, in particular whether it is previously known to the network or not.

The UE starts monitoring a PDCCH addressed to the MAC's, for instance, Temporary C-RNTI and/or C-RNTI.

A UE-specific scrambling is used for transmission on UL-SCH. However, as the UE may not yet have been allocated its final identity, the scrambling cannot be based on the C-RNTI. Instead, a temporary identity is used (TC-RNTI).

When the base station doesn't receive the Msg3 successfully or the base station fails at receiving the Msg3, the base station sends a PDCCH for scheduling of Msg3 retransmission, and/or the base station sends a HARQ feedback for the Msg3 as NACK.

If the UE receives a PDCCH for scheduling of Msg3 retransmission, the UE re-transmits a Msg3 for a RA procedure to the base station and re-starts a contention resolution timer. So, the step of S903 includes initial transmission or retransmission of Msg3.

Preferably, the Msg3 that message transmitted on UL-SCH containing a C-RNTI MAC CE or CCCH SDU, submitted from upper layer and associated with the UE Contention Resolution Identity, as part of a random access procedure.

Anyway, while the contention resolution timer is running, the UE keeps monitoring a PDCCH (S905).

If the MAC receives a PDCCH for scheduling of Msg3 retransmission, the MAC stops the contention resolution timer (S907).

Preferably, the PDCCH for scheduling of Msg3 retransmission is a scheduling information including/indicating the uplink resource for the retransmission of the Msg3, or a PDCCH with NDI not toggled compared to the NDI value of the previous transmission of the Msg3.

Meanwhile, if the MAC receives a HARQ feedback for the previous Msg3 transmission as NACK but the MAC has not received a PDCCH for scheduling of Msg3 retransmission yet, the MAC doesn't stop the contention resolution timer.

And if the MAC receives a PDCCH for scheduling of Msg4 transmission and if the UE considers that the Contention Resolution step is successful, the UE stops the contention resolution timer.

Preferably, if the UE receives the Msg4 that is addressed to its Temporay C-RNTI and CCCH SDU was included in Msg3 or if the UE receives the a PDCCH transmission for the Msg 4 that is addressed to C-RNTI and the C-RNTI MAC control element was included in the Msg3, the UE stops the contention resolution timer.

The Msg4 is transmitted on the DL-SCH, using the temporary identity from RAR for addressing the terminal on the L1/L2 control channel. Since uplink synchronization has already been established, HARQ is applied to the downlink signaling in this step. UEs with a match between the identity they transmitted in the Msg3 and the Msg4 received in the fourth step will also transmit a HARQ acknowledgement in the uplink.

If the MAC receives the PDCCH for scheduling of Msg3 retransmission, the UE performs retransmission of the Msg3 using the uplink resource indicated by the PDCCH for scheduling of Msg3 retransmission, and starts the contention resolution timer after/when/if the MAC retransmits the Msg3 (S909).

If the contention resolution timer expires, the MAC considers that the Contention Resolution step is unsuccessful.

Preferably, the contention resolution timer specifies a number of consecutive subframes during which the UE shall monitor a PDCCH after the Msg3 is transmitted.

More specifically, for a Bandwidth reduced Low complexity (BL) UE or a UE in enhanced coverage, or an Narrow Band Internet of Things (NB-IoT) UE, the UE starts contention resolution timer and restarts contention resolution timer at each HARQ retransmission of the bundle in the subframe containing the last repetition of the corresponding PUSCH transmission. So, if the UE is a BL UE or a UE in enhanced coverage, or an NB-IoT UE, the contention resolution timer is stopped in a subframe containing a last repetition of the corresponding PDCCH reception.

Preferably, the PDCCH refers to the PDCCH, EPDCCH, MPDCCH, R-PDCCH or NPDCCH. And the PDSCH refers to PDSCH or NPDSCH, PUSCH refers to PUSCH or NPUSCH and PRACH refers to PRACH or for NB-IoT to NPRACH.

Describing the present invention in point of view of HARQ operations, when a HARQ process generates and performs a transmission, the HARQ process instructs to the PHY layer to generate and perform a transmission of the Msg3 and/or the HARQ process stops the contention resolution timer which is currently running, if the MAC PDU stored in the HARQ buffer of the HARQ process was obtained from the Msg3 buffer.

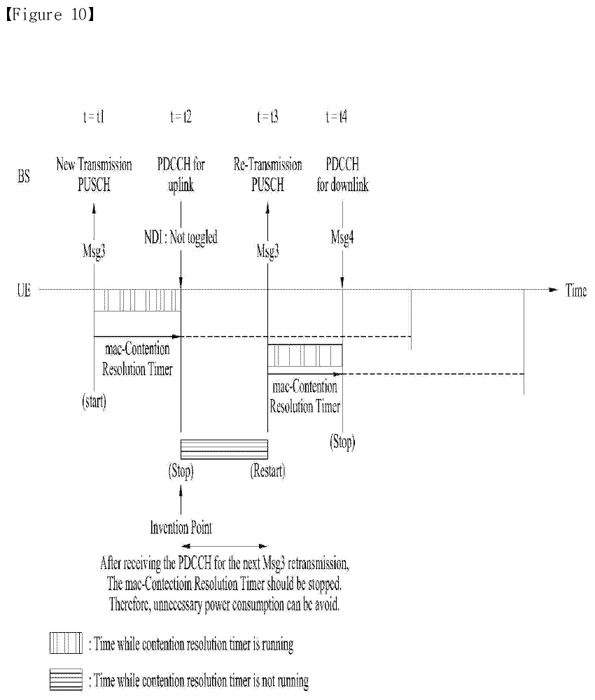

FIG. 10 is an example for performing a random access procedure in wireless communication system according to embodiments of the present invention.

FIG. 10 shows that an example of proposed stop condition for a contention resolution timer after receiving the scheduling of Msg3 retransmission as follows.

Once Msg3 on the PUSCH is transmitted, the MAC shall start contention resolution timer at t=t1.

After the UE receives a NDI not to have been toggled on the PDCCH for the next Msg3 retransmission, the UE stops the contention resolution timer at t=t2.

After the UE transmits the next Msg3 retransmission, the UE starts the contention resolution timer at t=t3.

The UE receives the Msg4 that is addressed to its Temporay C-RNTI and CCCH SDU was included in Msg3 or the UE receives the a PDCCH transmission for the Msg4 that is addressed to C-RNTI and the C-RNTI MAC control element was included in the Msg3 at t=t4.

At t=t4, the UE stops the contention resolution timer since the UE considers contention resolution successful.

As shown in FIG. 10, during form receiving the PDCCH for the next Msg3 retransmission to retransmitting the Msg3 (from t=t2 to t=t3), the contention resolution timer should be stopped. Therefore, unnecessary power consumption can be avoid.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a specific operation described as performed by the BS may be performed by an upper node of the BS. Namely, it is apparent that, in a network comprised of a plurality of network nodes including a BS, various operations performed for communication with an MS may be performed by the BS, or network nodes other than the BS. The term ‘eNB’ may be replaced with the term ‘fixed station’, ‘Node B’, ‘Base Station (BS)’, ‘access point’, etc.

The above-described embodiments may be implemented by various means, for example, by hardware, firmware, software, or a combination thereof.

In a hardware configuration, the method according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, or microprocessors.

In a firmware or software configuration, the method according to the embodiments of the present invention may be implemented in the form of modules, procedures, functions, etc. performing the above-described functions or operations. Software code may be stored in a memory unit and executed by a processor. The memory unit may be located at the interior or exterior of the processor and may transmit and receive data to and from the processor via various known means.

Those skilled in the art will appreciate that the present invention may be carried out in other specific ways than those set forth herein without departing from essential characteristics of the present invention. The above embodiments are therefore to be construed in all aspects as illustrative and not restrictive. The scope of the invention should be determined by the appended claims, not by the above description, and all changes coming within the meaning of the appended claims are intended to be embraced therein.

### INDUSTRIAL APPLICABILITY

While the above-described method has been described centering on an example applied to the 3GPP LTE and NR system, the present invention is applicable to a variety of wireless communication systems in addition to the 3GPP LTE and NR system.

1. A method for a user equipment (UE) operating in a wireless communication system, the method comprising:
starting a timer after a Msg3 for Random Access (RA) procedure is transmitted to a base station;
monitoring a Physical Downlink Control Channel (PDCCH) while the timer is running; and
stopping the timer if the PDCCH including uplink resource for the retransmission of the Msg3 is received.

2. The method according to claim 1, wherein the PDCCH including uplink resource for the retransmission of the Msg3 is a PDCCH with New Data Indicator (NDI) not toggled compared to a NDI value of previous transmission of the Msg3.

3. The method according to claim 1, wherein if the UE is a Bandwidth reduced Low complexity (BL) UE or a UE in enhanced coverage, or a Narrow Band Internet of Things (NB-IoT) UE, the timer is stopped in a subframe containing a last repetition of the corresponding PDCCH reception.

4. The method according to claim 1, wherein if a Hybrid-ARQ (HARD) feedback for the Msg3 transmission is received as Negative-ACK (NACK) but a PDCCH including uplink resource for the retransmission of the Msg3 is not received yet, the UE doesn't stop the timer.

5. The method according to claim 1, further comprising:
retransmitting the Msg3 using the uplink resource indicated by the PDCCH; and
starting the timer when the Msg3 is retransmitted.

6. The method according to claim 1, wherein a value of the timer specifies a number of consecutive subframes during which the UE shall monitor a PDCCH after the Msg3 is transmitted.

7. The method according to claim 1, wherein the PDCCH to be monitored while the timer is running is addressed to Temporary Cell-Radio Network Temporary Identifier (TC-RNTI) or Cell-Radio Network Temporary Identifier (C-RNTI).

8. A user equipment (UE) operating in a wireless communication system, the UE comprising:
a Radio Frequency (RF) module; and
a processor operably coupled with the RF module and configured to:
start a timer after a Msg3 for a Random Access (RA) procedure is transmitted to a base station,
monitor a Physical Downlink Control Channel (PDCCH) while the timer is running, and
stop the timer if the PDCCH including uplink resource for the retransmission of the Msg3 is received.

9. The UE according to claim 8, wherein the PDCCH including uplink resource for the retransmission of the Msg3 is a PDCCH with New Data Indicator (NDI) not toggled compared to a NDI value of previous transmission of the Msg3.

10. The UE according to claim 8, wherein if the UE is a Bandwidth reduced Low complexity (BL) UE or a UE in enhanced coverage, or a Narrow Band Internet of Things (NB-IoT) UE, the timer is stopped in a subframe containing a last repetition of the corresponding PDCCH reception.

11. The UE according to claim 8, wherein if a Hybrid-ARQ (HARD) feedback for the Msg3 transmission is received as Negative-ACK (NACK) but a PDCCH including uplink resource for the retransmission of the Msg3 is not received yet, the UE doesn't stop the timer.

12. The UE according to claim 8, wherein the processor is further configured to:
retransmit the Msg3 using the uplink resource indicated by the PDCCH, and
start the timer when the Msg3 is retransmitted.

13. The UE according to claim 8, wherein a value of the timer specifies a number of consecutive subframes during which the UE shall monitor a PDCCH after the Msg3 is transmitted.

14. The UE according to claim 8, wherein the PDCCH to be monitored while the timer is running is addressed to Temporary Cell-Radio Network Temporary Identifier (TC-RNTI) or Cell-Radio Network Temporary Identifier (C-RNTI).

15. The method of claim 1, wherein the UE is capable of communicating with at least one of another UE, a UE related to an autonomous driving vehicle, a base station and/or a network.

16. The UE of claim 8, wherein the UE is capable of communicating with at least one of another UE, a UE related to an autonomous driving vehicle, a base station and/or a network.
